(19) United States
(12) Patent Application Publication
(10) Pub. No.: US 2020/0175528 A1
(43) Pub. Date: Jun. 4, 2020

(54) PREDICTING AND PREVENTING RETURNS USING TRANSFORMATIVE DATA-DRIVEN ANALYTICS AND MACHINE LEARNING

(71) Applicant: ACCENTURE GLOBAL SOLUTIONS LIMITED, Dublin 4 (IE)

(72) Inventors: Purvika BAZARI, Gurgaon (IN); Nilesh Kumar GUPTA, Gurgaon (IN); Jennifer MEYERS, Manhattan Beach, CA (US); Benjamin D. VERLEY, Oakland, CA (US)

(73) Assignee: ACCENTURE GLOBAL SOLUTIONS LIMITED, Dublin 4 (IE)

(21) Appl. No.: 16/702,208

(22) Filed: Dec. 3, 2019

(30) Foreign Application Priority Data
Dec. 3, 2018 (IN) 201811045640

(51) Int. Cl. G06Q 30/02; G06F 16/2455; G06Q 10/08; G06N 20/00

(52) U.S. Cl. CPC G06Q 30/0201; G06F 16/24553; G06Q 30/0206; G06N 20/00; G06Q 10/0837; G06Q 10/0838; G06Q 10/087

(57) ABSTRACT

Systems and methods for predicting and preventing returns using transformative data-driven analytics and machine learning is provided. The systems and methods may include data stores to store and manage data within a network, as well as servers to facilitate operations using information from the one or more data stores. The systems and methods may also include an analytics subsystem having a data access interface to: receive data associated with a plurality of customers; and receive data associated with a plurality of transactions associated with the plurality of customers, where the plurality of transactions are transactions comprising at least a purchase, return, an exchange, or refund of an item. The systems and methods may further include a processor to: perform pre-processing of the data; apply feature engineering and business logic to the transformed returns data; determine root cause analysis based on the applied feature engineering and business logic; apply a machine learning technique based on the root cause analysis; and provide, to a user, at least one recommendation based on the applied machine learning technique.

### PRIORITY

This patent application claims priority to commonly assigned and co-pending Indian Patent Application Serial Number 201811045640, entitled “Returns Management System Using Transformative Data-Driven Analytics and Machine Learning,” filed Dec. 3, 2018, the disclosure of which is hereby incorporated by reference in its entirety.

### TECHNICAL FIELD

This patent application relates generally to returns management of goods and services, and more specifically, to systems and methods for predicting and preventing returns using transformative data-driven analytics and machine learning.

### BACKGROUND

Data analytics is an increasingly growing field that draws insights from raw information sources. The techniques for data analytics may vary, but they are typically used to collect, process, and analyze data for human consumption and decision-making purposes. Data analytics may be used to reveal trends and metrics that would otherwise be lost or “invisible” due to large quantities of unanalyzed data. Using this information in this way, however, may optimize processes and increase overall efficiencies in systems that would not otherwise be obtained.

Management of inventory and stock may be a challenging and daunting task. As an element of supply chain management, inventory management may include, among other things, aspects such as controlling and overseeing ordering inventory, storage of inventory, and controlling the amount of product for sale. In other words, inventory management is all about having the right inventory at the right quantity, in the right place, at the right time, and at the right cost. With so many moving parts, managing the flow of goods and services is complex but an intricate part of virtually every organizational entity.

However, there are several technical problems that continue to persist regarding the management of goods and services. For instance, it has become increasingly difficult to readily and consistently ensure the best and most efficient results. Automation has provided a more hands-off approach to track fast-moving inventory, but conventional systems for automation remain error-prone and are typically not comprehensive enough to provide customer-side diagnostics for various subsections of inventory management, such as returns management.

Accordingly, a more robust and holistic approach for returns management using transformative data-driven analytics and machine learning may be imperative to overcome the shortcomings of conventional systems and methods.

### BRIEF DESCRIPTION OF DRAWINGS

Features of the present disclosure are illustrated by way of example and not limited in the following Figure(s), in which like numerals indicate like elements, in which:

FIG. 1 illustrates a returns management system, according to an example;

FIG. 2 illustrates a data flow for a returns management system, according to an example;

FIG. 3A illustrates a chart for returns management, according to an example;

FIG. 3B illustrates a diagram for business logic behind return reasons in a returns management system, according to an example;

FIG. 3C illustrates a diagram for root causality using machine learning in returns management, according to an example;

FIG. 3D illustrates a graph for returns management, according to an example;

FIG. 4A illustrates a chart for machine learning results in a returns management system, according to an example;

FIG. 4B illustrates a diagram 400B for machine learning results in a returns management system, according to an example; and

FIG. 5 illustrates a method 500 for returns management, according to an example.

### DETAILED DESCRIPTION

For simplicity and illustrative purposes, the present disclosure is described by referring mainly to examples and embodiments thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

As described above, it has become increasingly challenging to implement returns management techniques to readily and consistently ensure the best and most efficient results. Automation and related solutions have offered some helpful assistance, but automation is not error-free nor is it typically capable and comprehensive enough to handle all aspects of returns management.

For example, effective inventory management (of goods or services) may involve more than just what items (in the example of goods) are stored in a particular warehouse, it may also entail a deeper understanding of which warehouse or shelf items are stocked, how much is needed per month, when the next shipment is coming in and in what quantities, when an item might run out, impact of delayed shipments from suppliers or to customers, etc. Furthermore, automation does not typically provide customer-side diagnostics for various subsections of inventory management, such as returns management.

In a retail environment, for instance, customers may return purchased goods or products for a variety of reasons. These returns may have a great impact on inventory management, not to mention customer experience, profits, and business strategies. Customer behavior is complex and not always direct or predictable. Although customer surveys are routinely issued to obtain feedback from customers, understanding the actual reasons why a customer returns goods or products may be elusive. If such information may be accurately, reliably, or comprehensively obtained, it may help reduce inefficiencies, improve customer retention, and enable organization entities to advance business practices to augment inventory replenishment, demand forecasting, channel allocation decisions, and other inventory management.

Retail analytics, as described herein, may focus on providing insights into sales, inventory, suppliers, customers, and other aspects for a merchant's decision-making process, with impact and improvement on inventory optimization, supply chain management, planning and forecasting, logistics management, and/or network and communications optimization. All of this may also lead to new (and better) product and service offerings. As a result, a data-driven approach using transformative analytics and machine learning to help organizations identify reasons (actual or deduced) for returns and improve overall inventory management is described herein.

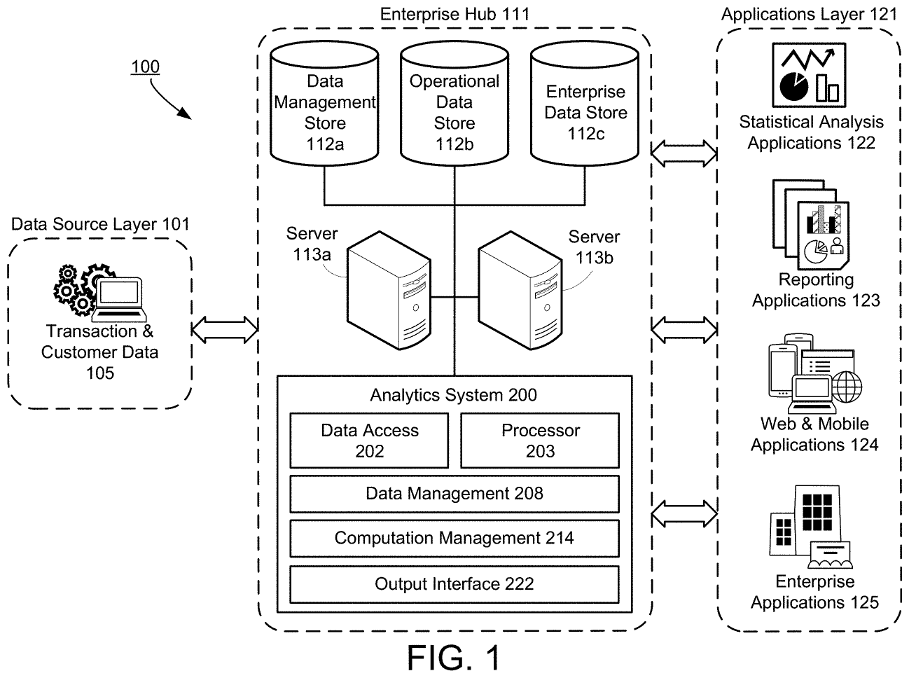

FIG. 1 illustrates a returns management system 100, according to an example. The returns management system 100 may be used to monitor and analyze data. In particular, the returns management system 100 may be used monitor and analyze data in an enterprise environment for an organizational entity. The organizational entity may be a financial entity, a commercial entity (e.g., a retailer or merchant), a government entity, or other entity. The returns management system 100 may also store information or be able to receive information from other sources associated with transaction data, customer data, or other related information. The returns management system 100 may include a clustering system, or other analysis engine to provide transformative analytics and machine learning to help organizational entities identify actual reasons for returns and improve overall inventory or returns management, as described herein.

The returns management system 100 may operate in a network or an enterprise environment where data is exchanged, and where products or services are being offered to customers. More specifically, the returns management system 100 may provide real-time or near real-time monitoring and analysis of data exchange and data storage, as well as an artificial intelligence system that uses machine learning, analytics, and predictive modeling. The enterprise environment of the returns management system 100 may include a data source layer 101, an enterprise hub 111, and an applications layer 121.

The data source layer 101 may include systems, subsystems, applications, and/or interfaces to collect information from various data sources, such as a transaction and customer data 105. It should be appreciated that the transaction and customer data 105 may be obtained from any number of data sources, such as an enterprise resource planning (ERP) systems and applications (hereinafter “ERP”), point of sale (POS) devices, documents, web feeds, machine and/or sensor data (hereinafter “sensor data”), and geolocation data, all of which may be distinct or integrated with the returns management system 100. The transaction and customer data 105 may include any data or information associated with a customer, transaction, or other similar data. The data source layer 101 may include other data or information sources as well. It should be appreciated that each of these data sources may further include its own data feed, storage, system, application, or other source for collecting and sending data and information, including third party or indirect sources.

The ERP may include one or more application servers that host various ERP applications. These may include, for example, a customer relationship management (CRM) platform, system, or application. The ERP may collect, store, manage, and interpret data associated with various enterprise functions or activities. The ERP may provide an integrated and continuously updated view of core business processes using common databases maintained by a database management system. The ERP may track enterprise resources (e.g., cash, raw materials, production capacity, etc.) as well as other information, such as corporate or business transactions (e.g., orders, purchase orders, payroll, ticketing, etc.). Furthermore, the applications that make up the ERP may share data across various departments (e.g., manufacturing, purchasing, sales, accounting, etc.) that provide the data. The ERP may facilitate information flow between many enterprise functions and may manage communications with stakeholders or other outside parties. As a result, the ERP may contain large quantities of information and data associated with a company and its employees.

The documents may provide another source of data. Data received at the documents may include files, emails, faxes, scans, or other documents that are transmitted, received, and stored in an enterprise environment.

The web feeds may be yet another source of data. Data received at the web feeds may include data from various web sources, such as websites, social media, syndication, aggregators, or from scraping. Websites may include uniform resource locator (URL) or other website identifier. This may also include RSS feeds, which allow users to access updates to online content. Data from social media may also include any type of internet-based application built upon creation and exchange of user-generated content, which may include information collected from social networking, microblogging, photosharing, news aggregation, video sharing, livecasting, virtual worlds, social gaming, social search, instant messaging, or other interactive media sources. Scraping may include web scraping, web harvesting, data scraping, or other techniques to extract data from websites or other Internet sources. These techniques may involve fetching (e.g., downloading content or data from a web page) and extraction (e.g., parsing, searching, reformatting, copying, compiling, monitoring, etc.) of data. Other forms of scraping may also include document object model (DOM) parsing, computer vision, and natural language processing (NLP) to simulate human browsing to enable gathering web page content for offline parsing.

The machine and sensor data may be another source of data and information in an enterprise environment. For example, in an enterprise network, there may be physical devices, vehicles, appliances, and other enterprise systems that are equipped with electronics, software, and sensors, where most, if not all, of these items are within a network and share some measure of connectivity which enable these and other pieces of equipment to connect, communicate, and exchange data. This may allow various systems, objects, and items in an enterprise environment to be detected, sensed, or remotely controlled over one or more networks, creating a vast array of enterprise functionalities. These may include abilities to provide data analytics on equipment, assessment of equipment health or performance, improved efficiency, increased accuracy or function, economic benefit, reduction of human error, etc. By creating a “smarter” environment and leveraging interactivity between various pieces of equipment in an enterprise network, the machine and sensor data may provide significant amounts of information and data that can be collected. Together with other technologies and systems described herein, the machine and sensor data may help enable the returns management system 100 have more insight into customer behavior.

The geolocation data may include information or data associated with identification or estimation of a geographic location of an object, such as a radar source, mobile device, or web-based computer or processing device. Geolocation data may provide specific geographic coordinates or data that may be used for monitoring location, distinct or together with, other various positioning systems or applications. For example, the geolocation data may include internet protocol (IP) address, media access control (MAC) address, radio-frequency identification (RFID), global positioning system (GPS), embedded software number, WiFi positioning system (WPS), device fingerprinting, canvas fingerprinting, etc. The geolocation data may include other self-disclosing or self-identifying information, including but not limited to country, region county, city, postal/zip code, latitude, longitude, time zone, domain name, connection speed, internet service provider (ISP), language, proxies, or other information that can be used to piece together and trace location. This and other data in the data source layer 101 may be collected, monitored, analyzed, and/or incorporated with the returns management system 100.

The enterprise hub 111 may collect, manage, process, and analyze information and data from the data source layer 101 and the applications layer 121. The enterprise hub 111 may be within general control of an enterprise, such as an organizational entity conducting operations, business, or other related activities. The enterprise hub 111 may collect, manage, process, and analyze information and data from the data source layer 101 and the applications layer 121. In order to do this, the enterprise hub 111 may include one or more data stores, one or more servers, and other elements to process data for its organizational purposes. For example, the enterprise hub 111 may include a data management store 112a, an operational data store 112b, and an enterprise data store 112c. The data management store 112a may store information and data associated with data governance, assets, analysis, modeling, maintenance, administration, access, erasure, privacy, security, cleansing, quality, integration, business intelligence, mining, movement, warehousing, records, identify, theft, registry, publishing, metadata, planning, and other disciplines related to managing data as a value resource.

The operational data store 112b may store information and data associated with operational reporting, controls, and decision-making. The operational data store 112b may be designed to integrate data from multiple sources for additional operations on that data, for example, in reporting, controls, and operational decision support. Integration of data at the operational data store 112b may involve cleaning, resolving redundancy, checking against business rules, and other data integration techniques, such as data virtualization, federation, and extract, transform, and load (ETL). The operational data store 112b may also be a source of data for an enterprise data store 112c, which may be used for tactical and strategic decision support.

The enterprise data store 112c may store information and data associated with reporting and data analysis, and may be instrumental to various business intelligence functions. For example, the enterprise data store 112c may be one or more repositories of integrated data (e.g., from the operational data store 112b) and used to store current and historical data and to create analytical report(s) for advanced enterprise knowledge. Data passed through the enterprise data store 112c may also involve cleansing to ensure data quality and usage. ETL may also be used, as well as other techniques, involving staging, data integration, and access features. Ultimately, data in the enterprise data store 112c may be transformed and catalogued so that it may be used for data mining, analytics, and other business intelligence purposes, such as marketing, decision support, etc. Other data stores may also be provided in the enterprise hub 111, such as data marts, data vaults, data warehouses, data repositories, etc.

It should be appreciated that the data stores described herein may include volatile and/or nonvolatile data storage that may store data and software or firmware including machine-readable instructions. The software or firmware may include subroutines or applications that perform the functions of the system 100 and/or run one or more application that utilize data from the system 100. Other various server components or configurations may also be provided.

The enterprise hub 111 may further include a variety of servers 113a and 113b that facilitate, coordinate, and manage information and data. For example, the servers 113a and 113b, as well as others described herein, may include any number or combination of the following servers: exchange servers, content management server, application servers, database servers, directory servers, web servers, security servers, enterprise servers, and analytics servers. Other servers to provide data security and protection may also be provided.

The enterprise hub 111 may also include an analytics system 200. The analytics system 200 may include various layers, processors, systems or subsystems. For example, the analytics system 200 may include a data access interface 202, a processor 203, a data management subsystem 208, a computation management subsystem 214, and an output interface 222. Other layers, processing components, systems or subsystems, or analytics components may also be provided. It should be appreciated that the data management 208 and computation management 214 may be other processing components integrated or distinct from processor 203 to help facilitate data processing by the analytics system 200 as described herein. Features and functionalities may be particularly helpful in data management, predictive analytics, and machine learning.

There may be many examples of hardware that may be used for any of the servers, layers, subsystems, and components of the analytics system 200 or the returns management system 100 described herein. For example, the processor 203 may be an integrated circuit, and may execute software or firmware or comprise custom processing circuits, such as an application-specific integrated circuit (ASIC) or field-programmable gate array (FPGA). The data access interface 202 and output interface 222 may be any number of hardware, network, or software interfaces that serves to facilitate communication and exchange of data between any number of or combination of equipment, protocol layers, or applications. For example, the data access interface 202 and output interface 222 may each include a network interface to communicate with other servers, devices, components or network elements via a network in the returns management system 100.

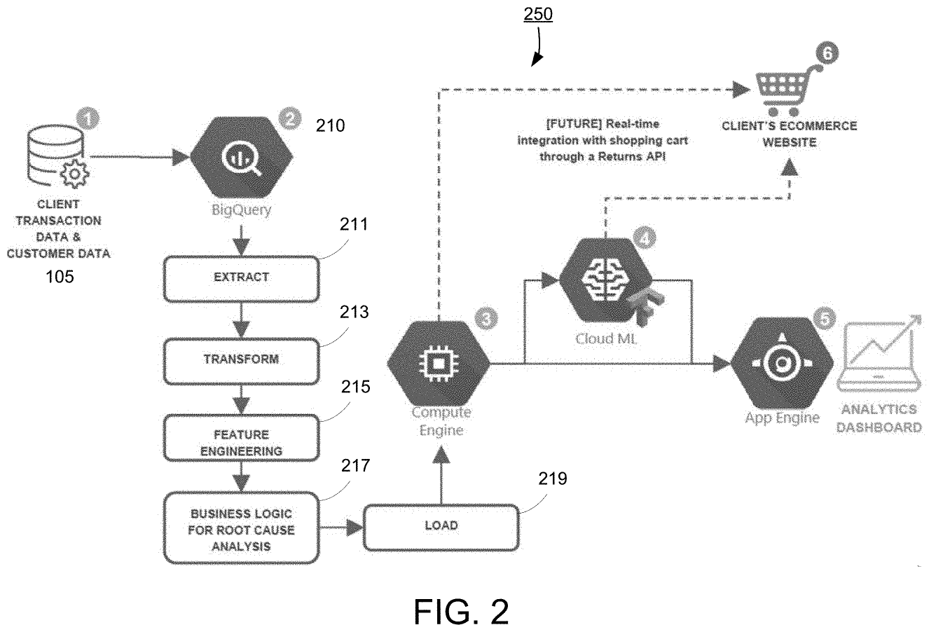

It should be appreciated that the analytics system 200 may be implemented in a distributed manner as well (completely or partly) across multiple devices and systems (e.g., personal devices such as smartphones, laptops, or server computers), or some (or all) components may be installed on the same device. Components on separate devices may use any suitable communications technique to transmit data between one another. For example, in an implementation, the analytics system 200 may provide inventory and returns management using transformative data-driven analytics and machine learning. In an example, the analytics system 200 may be an integrated system as part of the enterprise hub 111 shown in FIG. 1. More detail of aspects of the analytics system 200 may be provided in FIG. 2.

The returns management system 100 may also include an applications layer 121. The applications layer 121 may include any number or combination of systems and applications that interface with users or user-interfacing tools in an enterprise or a personal environment. For example, the applications layer 121 may include statistical analysis applications 122, reporting applications 123, web and mobile applications 124, and enterprise applications 125.

The statistical analysis applications 122 may include systems or applications that specialize in statistical calculations or econometrics. These may include, but not limited to, those by Tableau®, Domo®, Salesforce®, JMP®, MATLAB®, QlikSense®, SPSS®, SAS®, State®, Alteryx®, Analytica®, etc. The reporting applications 123 may include systems or applications that that provide reporting, for example, in business intelligence, visualization, and other useful enterprise reporting tools. These may include, but not limited to, Dundas BI®, Domo®, Sisense®, Yellowfin®, Sharepoint®, SAP®, etc.

The web and mobile applications 124 may include Internet-based or mobile device based systems or applications of various users, namely those in an enterprise environment. The enterprise applications 125 may include systems or applications used by an enterprise that is typically business-oriented. For example, these may include online payment processing, interactive product cataloguing, billing systems, security, enterprise content management, IT service management, customer relationship management, business intelligence, project management, human resource management, manufacturing, health and safety, automation, or other similar system or application. In an example, these enterprise applications 125 may be external or remote to the enterprise hub 111.

It should be appreciated that a layer as described herein may include a platform and at least one application. An application may include software comprised of machine-readable instructions stored on a non-transitory computer readable medium and executable by a processor. The systems, subsystems, and layers shown in FIG. 1 or other figure may include one or more servers or computing devices. A platform may be an environment in which an application is designed to run on. For example, a platform may include hardware to execute the application, an operating system (OS), and runtime libraries. The application may be compiled to run on the platform. The runtime libraries may include low-level routines or subroutines called by the application to invoke some of behaviors, such as exception handling, memory management, etc., of the platform at runtime. A subsystem may be similar to a platform and may include software and hardware to run various software or applications, and may be local, remote, or cloud or web based.

It should be appreciated that a single server is shown for each of the servers 113a and 113b, and/or other servers within the systems, layers, and subsystems of the returns management system 100, as described herein. However, it should be appreciated that multiple servers may be used for each of these servers, and the servers may be connected via one or more networks. Also, middleware (not shown) may include in the returns management system 100 as well. The middleware may include software hosted by one or more servers, or it may include a gateway or other related element. Such middleware may be used to enhance data processing, edge-based analytics, or other related operations. Furthermore, it should be appreciated that some of the middleware or servers may or may not be needed to achieve functionality. Other types of servers, middleware, systems, platforms, and applications not shown may also be provided at the back-end to facilitate the features and functionalities of the returns management system 100.

The returns management system 100, as described herein, may provide several benefits and advantages over conventional techniques. For example, the returns management system 100 may use machine learning and data-driven analytics to obtain a more reliable and accurate assessment of customer behavior, especially as it pertains to returns of various goods, products, or services. In this way, the returns management system 100 may better engage with customers, incorporate new business models, understand impact of pricing and promotion decisions, determine attributes of products with high propensity for returns and a plan accordingly, identify or remove customers who produce negative economic value, etc. Additionally, the returns management system 100 may provide predictive capabilities, which may improve inventory management, demand forecasting, channel allocation decisions, etc.

The returns management system 100 may also be friction driven. In other words, friction may be defined by a level of effort applied to a user or applicant to complete an online survey. As stated above, customer behavior typically indicates that it is cumbersome to gather comments or feedback on a particular item or transaction. Such processes often hinder customers from interacting and reduce user experience. However, if friction is reduced, a customer may have a better experience. The returns management system 100 may leverage the power of analytical business intelligence and other features to provide users with less variations of frictions yet provide more targeted support for their comprehensive retail experience.

The returns management system 100 may also be platform independent. In other words, online applications associated with the returns management system 100 may be used across various platforms, such as Windows, MAC, Unix, or other operating systems. The returns management system 100 may also be hosted in the cloud, provisioned/accessed via the web/cloud, or provided locally/remotely via on-site premises.

Within the returns management system 100, there may be a large amount of data that is exchanged, and the exchanged data may sensitive, e.g., may include personally identifying information (PII). Many of the conventional systems for protecting sensitive data are static and not dynamic. With new laws and regulations surrounding sensitive personal data in possession by organizational entities, the returns management system 100 may be able to collect, analyze, and process data within these legal constraints.

The General Data Protection Regulation (GDPR), for example, is a new regulation recently passed by the European Parliament (EP), the Counsel of the European Union (EU), and the European Commission (EC) in order to strengthen and unify data protection for individuals within the EU. The GDPR specifically addresses the export of personal data outside of the EU and aims to give control back to citizens and residents over their personal data, as well as to simplify the regulatory environment for international business. These and other new laws are having an impact to companies, organizations, and entities that are entrusted or in possession of private or personal data.

In order to comply with these new laws and regulations, such as the GDPR, organizational entities may need to understand what data and information they possess, why they possess it, and the potential sensitivity of that that data. The returns management system 100, as described herein, may provide a more dynamic and scientific approach to provide monitoring, diagnostics, and analytics to using and processing such potential sensitive data in an enterprise network without compromising legal regulations and mandates.

Ultimately, the returns management system 100 may provide a data-driven approach using transformative analytics and machine learning to help organizational entities identify actual reasons for returns and improve overall inventory management.

FIG. 2 illustrates a data flow 250 for a returns management system, according to an example. At 1, client transaction data and/or customer data may be received from any variety of data sources, as described herein, such as the data sources in data source layer 101 of FIG. 1. In an example, data may be accessed from an external data source by the data access interface 202 of FIG. 1. The external data source may be any data source from the data source layer 101, enterprise hub 111, and applications layer 121 of the returns management system 100 of FIG. 1, as well as other data sources not depicted. The data access interface 202 may optionally store some or all (or none) of the data in an optional data cache, which may be local or remote.

The imported data may then be passed to a data management subsystem 208 (FIG. 1) for processing prior to performing analytics. For example, the data management subsystem 208 may organize the data by grouping, ordering, transforming, or cleaning the data in such a way that facilitates input of the data into analytics processing. At 2, for example, data may be prepared and pre-processed by a data warehouse server, such as BigQuery or other similar server. This may include data extraction 211, transformation 213, feature engineering 215, business logic for root cause analysis 217, and for loading 219 unto a compute engine at the processor 203 (FIG. 1) and/or computation management system 214 (FIG. 1) of the analytics system 200. In this way, the data warehouse server may store and query massive datasets at a time without excessive expense and complexity. This may also provide access to data for subsequent actions in the returns management process.

The data management subsystem 208 may use one or more transformation rules that specify one or more rules to apply to the data for processing. In an example, the transformation rules may be accessed from storage (e.g., from data store). Additionally or alternatively, the transformation rules may be input by a user. For example, the data management subsystem 208 may provide a user interface to a user that enables the user to specify one or more transformation rules. The data management subsystem 208 may also implement data management without rules (e.g., non-rule-based) and rely on other data management schemes.

Although the data flow 250 shown in FIG. 2 is depicted in an integrated manner, it should be appreciated that the analytics system 200 may be implemented in a distributed manner as well (completely or partly) across multiple devices and systems (e.g., personal devices such as smartphones, laptops, or server computers), or some (or all) components may be installed on the same device. Components on separate devices may use any suitable communications technique to transmit data (represented by the arrows) between one another. For example, in an implementation, the analytics system 200 may provide inventory and returns management using machine learning and data-driven analytics. In an example, the analytics system 200 may be an integrated system as part of the enterprise hub 111 shown in FIG. 1.

The data management subsystem 208 may identify different types of variables that are specified by the user, and separate the variables according to the identified type. Some types of variables may be used as inputs to the analytics process, while other types of variables may be used evaluation criteria to evaluate the resulting analytics solutions. As such, the system may enable not only automated processing of data, but also automated evaluation of the resulting analytics solutions.

The variables determined by the data management subsystem 208 and a parameter set generated by the processor 203 may be provided to the computation management subsystem 214. The computation management subsystem 214 may send the processed data including the parameter set 206 and one or more chosen algorithms or learning sets to one or more computational nodes to perform machine learning operations.

Referring back to FIG. 2, the compute engine, at 3, in the computation management subsystem 214 may further prepare data for non-deep learning models and perform root cause analytics. At 4, deep learning models may be trained, e.g., in a Cloud machine learning (ML) model. Deep learning is a machine learning (ML) technique that teaches computers to do what comes naturally to humans (e.g., learn by example). In deep learning, a computer model may learn to perform classification tasks directly from data, such as images, text, sound, etc. In this case, data from the data warehouse server may be used for deep learning in the returns management process. Models, such as Cloud ML or other similar models, may be trained using large sets of labeled data and neural network architectures that contain any number of layers (the “deeper” the training, the greater number of “layers” may be involved). Convolutional neural networks (CNN) may be used, in which a need for manual extraction may be reduced or eliminated. Other various neural networks may also be provided, such as feedforward neural networks, radial basis function neural networks, self-organizing neural networks, recurrent neural networks, sparse neural networks, and modular neural networks, to name a few. Other machine learning techniques may also be provided, such as the use of a tree-based model, a Bayesian network, a support vector, clustering, a kernel method, a spline, a knowledge graph, or an ensemble of one or more of these and other techniques.

At 5, data may be integrated with any of the applications in the applications layer 121, which may be presented via a dashboard with root cause analytics, return predictions, and other presentable results. Root cause is the fundamental failure or breakdown of a process, which when resolved, prevents a recurrence of the problem. In some examples, an approach to get to the true root causes of a particular process problem may be referred to as root cause analysis (RCA). In other words, root cause analysis (RCA) may be a technique to address a problem or non-conformance in order to get to the “real” reason of the problem at hand, and it may be used to correct or eliminate the cause, and thereby prevent the problem from recurring. In general, and as shown at 5, questions of why returns of goods or products were made would be asked, investigations into whether these reasons are valid or true, implementing logic and verification actions to evaluate countermeasures, ensuring system tolerance, etc. Furthermore, at 5, visualization for these root cause analytics, return predictions, and other presentable results may be made via a dashboard for any interested user, as described below.

At 6, a client's e-commerce website, for example, may call returns application program interface (returns API) and generate dynamic responses or recommendations to a customer. Other various features and functions may also be provided, or elaborated on in detail herein.

In an example, the computation management subsystem 214 may evaluate generated solutions based on user-specified criteria, and iterate through multiple sets of solutions to identify solutions that satisfy the criteria. The computation management subsystem 214 may identify and apply one or more generalized heuristic supervised learning algorithms to the computation process to improve the efficiency of the solution search, based on the solutions generated by the computational nodes. The supervised learning algorithms may utilize variables specified by the user to facilitate searching for particular solution(s), among the potentially many solutions generated by the computation nodes, that are meaningful to the user. The computation management subsystem 214 may also provide a user interface that shows the user the progress of the clustering and shows cluster solutions.

The computation management subsystem 214 may also provide a user interface that shows the user the progress of the machine learning and/or training sets and shows solutions. The user interface may be an output interface, like that shown in FIG. 1, which may in turn include a visualization interface that may show solution(s) and other information pertaining to the solutions. A report generator may generate report regarding the solutions.

In some implementations, the visualization interface may also provide the solution(s) and/or evaluation results to a solution export subsystem. The solution export subsystem may provide feedback information to the analytics system 200 or other systems in the returns management system 100. In this way, the analytics system may be fine-tuned to provide improved and more accurate calculations and computations. As such, in some implementations, the analytics system 200 may enable more than just an analytics tool, but also enable a feedback-based and connected enterprise system.

The output interface 222 may include a visualization interface that provides the resulting solution(s) and results of the evaluation to a report generator, which may generate a report to be output to the user, such as a security manager or other user. The report may include various types of information regarding the evaluation of the solution(s) or other calculation, and may enable a user to adjust one or more variables of the analytics system 200 to fine-tune the operations. In some implementations, it should be appreciated that the user interfaces, including the output interface 222, may be custom-designed user interfaces that facilitate some portion of the overall activity and, in some cases, may be used by multiple users with different roles.

It should be appreciated that while machine learning techniques are described, other various techniques may also be provided. These may include clustering, modeling, simulation, predictive analytics, use of knowledge graphs, as well as various other statistical or data-driven approaches. It should also be appreciated that deep learning and other related artificial intelligence (Al) based approaches may also be provided.

The analytics system 200 may coordinate and facilitate a distributed process of solution generation and evaluation for root cause analysis, and streamline the tasks and roles that potentially involve the participation of multiple people. As such, the analytics system 200 may monitor and analyze data exchanged in an enterprise network to streamline understanding customer behavior, especially as it pertains to returns of goods and services, all the while minimizing risk to an organization entity, reducing potential fraudulent customer behavior, enhancing ease of use for users, and improving returns management efficiencies and profits.

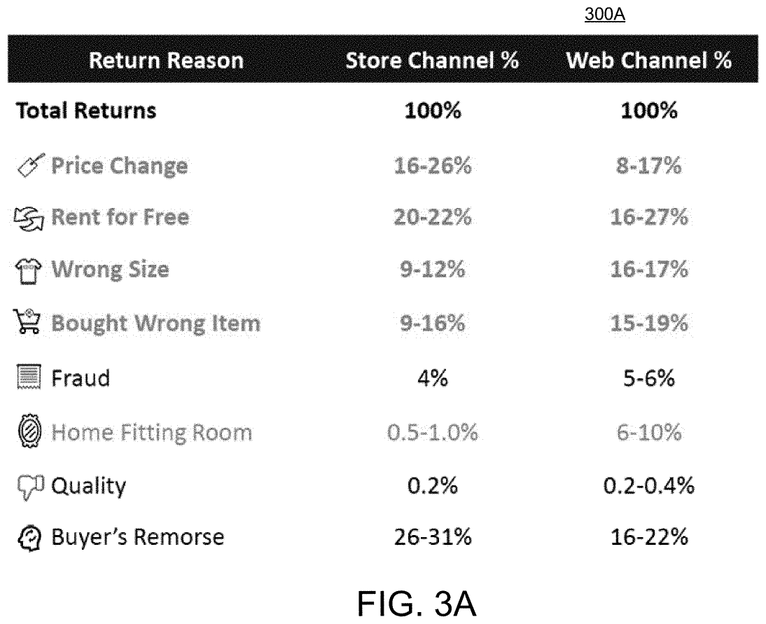

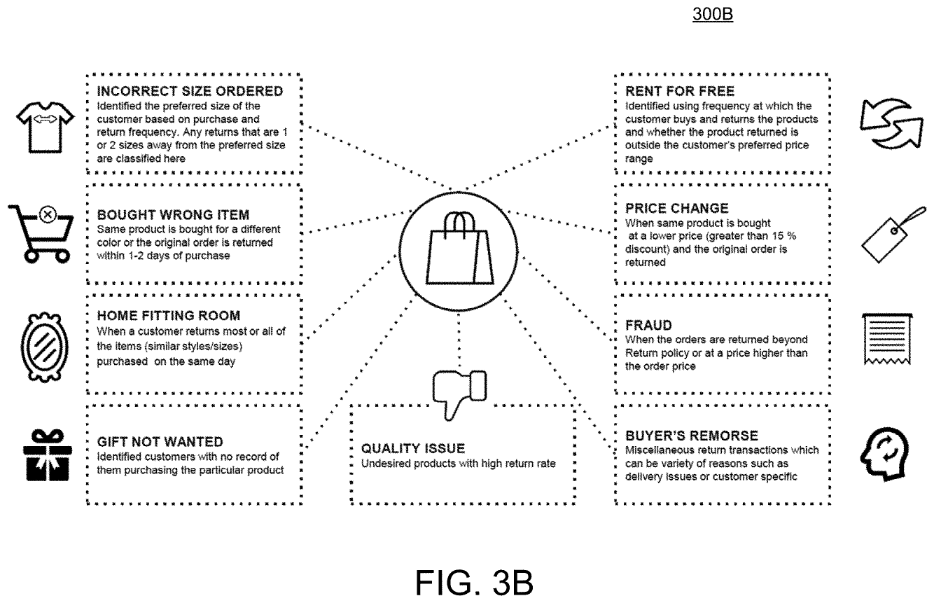

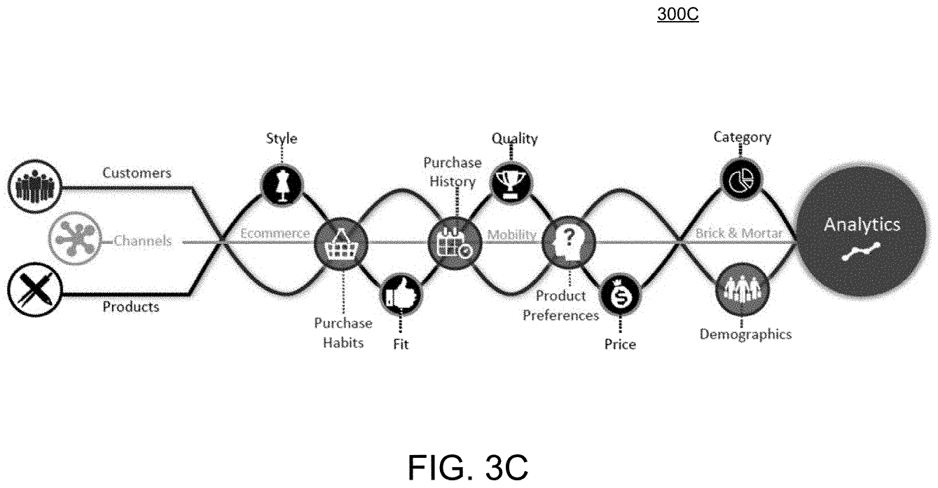

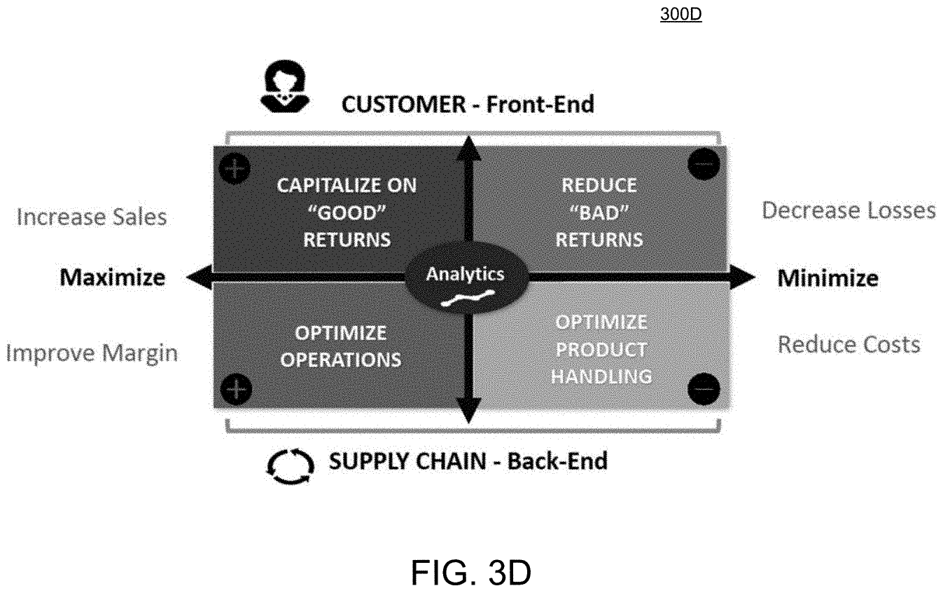

FIG. 3A illustrates a chart 300A for returns management, according to an example. As shown, the chart 300 may depict various return reasons via store channels (brick and mortar retail) and web channels (online retail). Here, percentages may be shown for various return reasons, such as price change, rent for free, wrong size, bought wrong item, fraud, home fitting room, quality, and buyer's remorse in association with their respective retail channel (physical or online). FIG. 3B illustrates a diagram 300B for business logic behind return reasons in a returns management system 100, according to an example.

“Price change,” for example, may typically involve a subsequent reduction of price, which may prompt a customer to return his or her purchase, and usually with a repurchase of the same item for the reduced price. “Rent for free” may involve a particular customer behavior where the customer has no intention of keeping the purchased items. He or she may purchase the item really only to “rent” it, predetermining to return it after a limited use of that item. For example, a customer may purchase an expensive TV for a Super Bowl or sporting event with the intention of returning the perfectly good item after the sporting event. If this occurs too frequently, it may be a particular customer behavior that needs to be deterred.

“Wrong size” returns may typically involve clothing or other wearables where size and fit are only fully determined upon wearing. At times, online retailers allow a customer to purchases the same item in various sizes, effectively causing returns of items that do not fit. This may be commonly referred to as “home fitting room.” Other return reasons may include purchasing a “wrong item,” “buyer's remorse,” “poor quality,” or “fraud.” It should be appreciated there may be other reasons for returns not described or shown in FIGS. 3A and 3B.

FIG. 3C illustrates a diagram 300C for root causality using machine learning in returns management, according to an example. As shown, the diagram 300C may depict a web of interconnectedness between customer, various purchasing channels, and products and how analytics may be used to help determine things like purchase habits, purchase history, product preferences, demographics, size and fit, quality, category of items, style or other preferences. The analytics system 200, as described herein, may use a combination of business rules and robust algorithms to analyze these inputs and map them into meaningful patterns. These patterns may be reworked with data science and other feedback input to improve logic that increase accuracy and predictive ability. Furthermore, these algorithms, together with deep learning and Al-based techniques, as described herein, may be applied to generate additional learnings, as well as to improve cloud implementation for monitoring training, and improve outcomes. Ultimately, data-driven analytics and machine learning may determine overt and/or covert behavorial reasons behind returns, and therefore better predict, prevent, and/or capitalize on such behaviors and patterns.

FIG. 3D illustrates a graph 300D for returns management, according to an example. As shown, using data-driven analytics and machine learning at the analytics system 200, as described herein, may allow users or merchants to think differently about returns management. Managing returns successfully in this mode may allow retailers to treat returns as valuable insights into their customers, categories, and/or business models, rather than a customer service or a revenue drain. The returns management system 100, as described herein, may therefore help identify more accurate reasons for returns so that better systems and solutions maybe implemented for future resolution or negative behavior prevention.

In an area where customer feedback is unreliable and a high percentage of returns are made with relative uncertainty (usually in order to balance customer experience), the returns management system 100, as described herein, may enable a user or merchant to determine root causality of returns with a higher rate of accuracy and reliability. This may allow users or merchants to acquire actionable insights and better engage with customers, incorporate new business models, understand impact of pricing and promotion decisions, determine attributes of products with high propensity for returns and a plan accordingly, identify or remove customers who produce negative economic value, etc. In addition, these enhancements may further result in reduced loss of revenue, higher profitability, and improved customer experience not otherwise achievable through convention means such as automation.

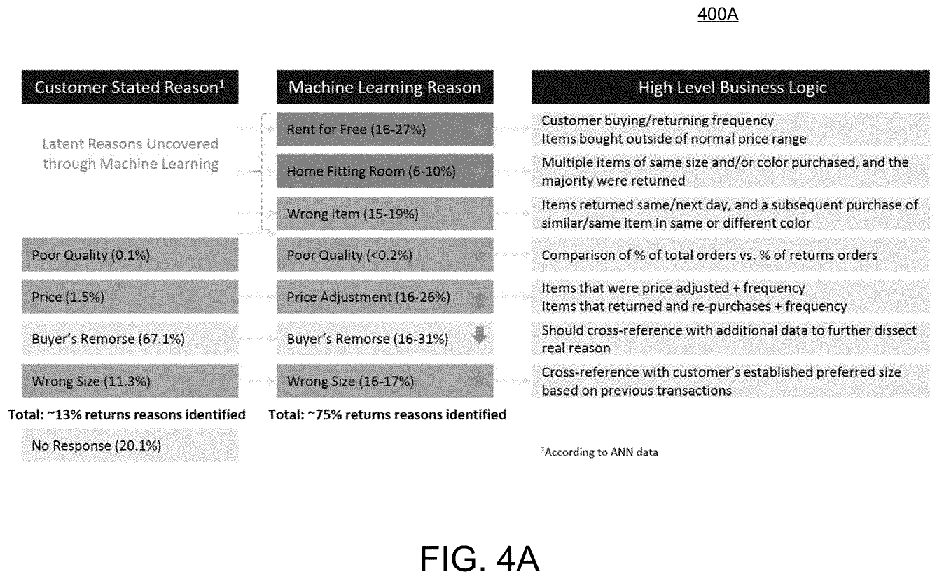

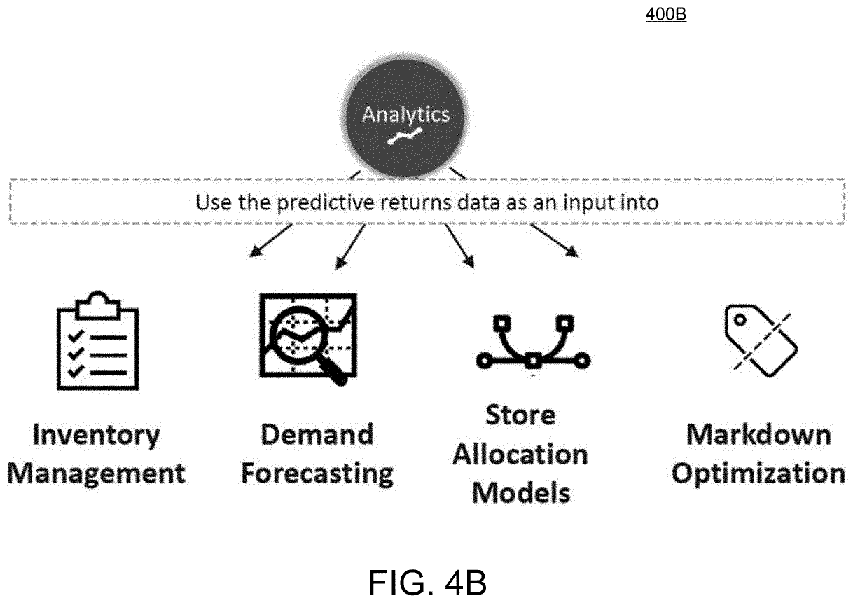

FIG. 4A illustrates a chart 400A for machine learning (ML) results in a returns management system 100, according to an example. As shown, a comparison of customer stated reasons may be made with machine learning (ML) reasons, and such a comparative analysis may confirm accuracy or reliability of reasons for returns. In an example, customer-stated reasons may typically involve poor quality of item, pricing issues, remorse or no reason, or wrong size. In this scenario, this may leave many other reasons unidentified (e.g., up to 20.1%). Using machine learning (ML) and data-driven analytics in returns management, as described herein, it may be determined that “rent for free,” “home fitting room,” and “wrong item” contributed to a significantly larger portion of customer returns than previously understood or from the stated reasons provided by customers. This combined information may be used, for example, by the merchant to improve business policies or promotional offerings.

In some examples, this information may generate business insights or logic valuable to merchants or other entities providing goods or services. For instance, some business insights may inform merchants that customers are buying and returning more of the items purchased outside of normal price ranges, that multiple items of a particular size or color are being purchases and returned more than other sizes or colors, certain items purchased at a particular date/time have a greater likelihood of being returned, certain dates/times are more popular for returning items, etc.

FIG. 4B illustrates a diagram 400B for machine learning results in a returns management system, according to an example. As shown, understanding actual return reasons may enable the returns management system 100 to provide predictions. Thus, another benefit may include better understanding and awareness of when, why, or where a future return would happen with a relatively high confidence level. As shown, knowing when, why, or where a return may likely occur at the time the customer is purchasing an item may have a positive impact on how a company or user conducts business or how it may want to interact with that customer or that particular product. This may also impact inventory management, demand forecasting, store allocation, and markdown optimization, to name a few.

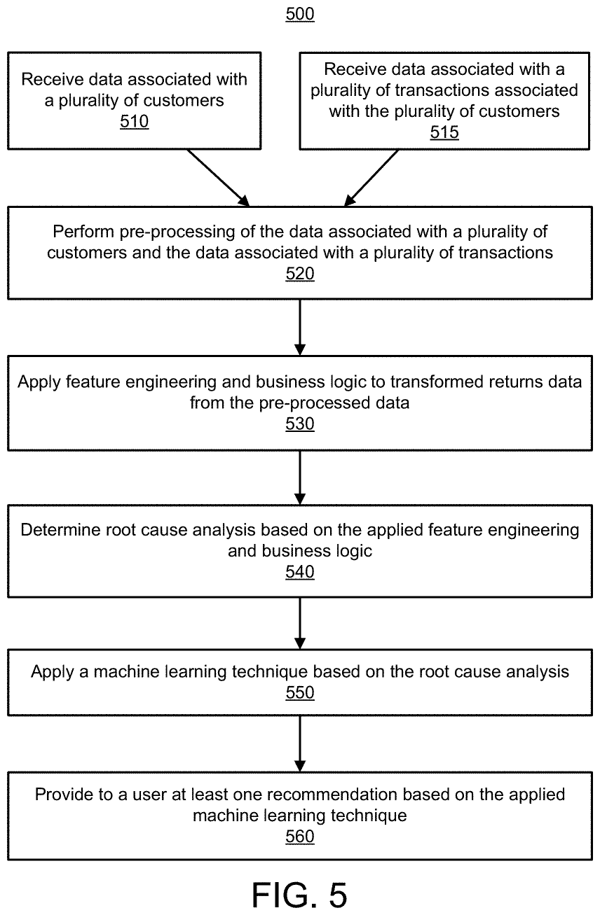

FIG. 5 illustrates a method 500 for returns management, according to an example. The method 500 is provided by way of example, as there may be a variety of ways to carry out the method described herein. Although the method 500 is primarily described as being performed by system 100 as shown in FIGS. 1A-1B, system 300 as shown in FIG. 3, or computer system 400 of FIG. 4, the method 500 may be executed or otherwise performed by other systems, or a combination of systems. Each block shown in FIG. 5 may further represent one or more processes, methods, or subroutines, and one or more of the blocks may include machine-readable instructions stored on a non-transitory computer-readable medium and executed by a processor or other type of processing circuit to perform one or more operations described herein.

At 510, the processor 203 or data access interface 202 may receive data associated with a plurality of customers. At 515, the processor 203 or data access interface 202 may receive data associated with a plurality of transactions associated with the plurality of customers. In some examples, the plurality of transactions may be transactions that include a purchase, return, an exchange, or refund of an item, or other transaction. In some examples, the data associated with a plurality of customers and the data associated with a plurality of transactions may each be received from a data source. As described herein, the data source may include, but not limited to, a website, a document, enterprise resource planning (ERP) system, a point of sale (POS) device, a database, a web feed, a sensor, a geolocation data source, a server, an analytics tool, a mobile device, a reporting system, and/or other source.

At 520, the processor 203 may perform pre-processing of the data associated with a plurality of customers and the data associated with a plurality of transactions. In some examples, and as described above, the pre-processing of the data may include extracting relevant returns data from the data associated with a plurality of customers and the data associated with a plurality of transactions. The pre-processing of the data may also include transforming the returns data by at least one of grouping, ordering, and/or cleaning. In some examples, the transforming of the returns data may be to facilitate downstream processing. Additionally or alternatively, it should be appreciated that pre-processing of the data may be performed in conjunction with a data warehouse server or other network element.

At 530, the processor 203 may apply feature engineering and business logic to the transformed returns data. At 540, the processor 203 may determine root cause analysis based on the applied feature engineering and business logic. At 550, the processor 203 may apply a machine learning technique based on the root cause analysis. In some examples, the machine learning technique may perform predictive modeling or forecasting associated with future returns. As described above, the machine learning technique may include any number of models, such as a tree-based model, a Bayesian network, a support vector, clustering, a kernel method, a spline, or a knowledge graph. Additionally or alternatively, the machine learning technique may include a deep learning technique using at a neural network and training at least one deep learning model. In some examples, the deep learning model may include, but not limited to, a convolutional neural network, a feedforward neural network, a radial basis function neural network, a self-organizing neural network, a recurrent neural network, a sparse neural networks, a modular neural network, or other network.

At 560, the processor 203 may provide, to a user, at least one recommendation based on the applied machine learning technique. In some examples, the at least one recommendation may be associated with customer engagement, business model efficiency, pricing and promotional strategies, inventory management decisions, future returns predictions, customer behavior trends, and/or other recommendation subject matter. The method 500 may also include transmitting, by an output interface, the at least one recommendation to the user at a user device.

Ultimately, the returns management system may suggest new opportunities to reduce returns and better manage inventory, resulting in increased sales and margins and reduced operating costs. Other advantages may include new ways to engage with customers. For example, this may include providing more relevant alternative products or size recommendations in real time or near real time. Another advantage may include incorporating new business models, such as creating a dress rental business for categories with high “rent for free” propensities. Yet another advantage may include a better understanding of the impact of pricing or promotional strategies, which may be used to deduct price adjustment sales from full price sales statistics, or deduct price adjustment sales from promotional sales statistics. Moreover, a merchant may use the returns management system to help identify and eliminate “bad” customers by flagging, disallowing, or exploring ways to deter repeat offenders and their negative purchasing or returns behaviors.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
one or more data stores to store and manage data within a network;
one or more servers to facilitate operations using information from the one or more data stores;
an analytics subsystem that communicates with the one or more servers and the one or more data stores in the network, the analytics subsystem comprising:
a data access interface to:
receive data associated with a plurality of customers;
receive data associated with a plurality of transactions,
the plurality of transactions associated with the plurality of customers,
the plurality of transactions are transactions comprising at least a purchase, return, an exchange, or refund of an item, the data associated with the plurality of customers is received from a data source, and
the data associated with the plurality of transactions is received from the data source; and
a processor to:
perform pre-processing of the data associated with the plurality of customers and the data associated with the plurality of transactions, where the pre-processing comprises:
extracting relevant returns data from the data associated with the plurality of customers and the data associated with the plurality of transactions; and
transforming the returns data by at least one of grouping, ordering, or cleaning,
the transforming of the returns data to facilitate downstream processing;
apply feature engineering and business logic to the transformed returns data;
determine root cause analysis based on the applied feature engineering and business logic;
apply a machine learning technique based on the root cause analysis,
the machine learning technique performing predictive modeling or forecasting associated with future returns; and
provide, to a user, at least one recommendation based on the applied machine learning technique,
the at least one recommendation associated with at least one of: customer engagement, business model efficiency, pricing and promotional strategies, inventory management decisions, future returns predictions, or customer behavior trends.

2. The system of claim 1, where the data source comprises at least one of a website, a document, enterprise resource planning (ERP) system, a point of sale (POS) device, a database, a web feed, a sensor, a geolocation data source, a server, an analytics tool, a mobile device, or a reporting system.

3. The system of claim 1, where the machine learning technique comprises at least one of a tree-based model, a Bayesian network, a support vector, clustering, a kernel method, a spline, or a knowledge graph.

4. The system of claim 1, where the machine learning technique comprises a deep learning technique using at a neural network and training at least one deep learning model.

5. The system of claim 4, where the deep learning model comprises at least one of a convolutional neural network, a feedforward neural network, a radial basis function neural network, a self-organizing neural network, a recurrent neural network, a sparse neural networks, or a modular neural network.

6. The system of claim 1, where pre-processing of the data is performed in conjunction with a data warehouse server.

7. The system of claim 1, further comprising:
an output interface to transmit the at least one recommendation to the user at a user device.

8. A method for digital content security and communication, comprising:
receive data associated with a plurality of customers;
receive data associated with a plurality of transactions associated with the plurality of customers,
where the plurality of transactions are transactions comprising at least a purchase, return, an exchange, or refund of an item, and
where the data associated with the plurality of customers and the data associated with the plurality of transactions are received from a data source;
perform pre-processing of the data associated with the plurality of customers and the data associated with the plurality of transactions, where the pre-processing comprises:
extracting relevant returns data from the data associated with the plurality of customers and the data associated with the plurality of transactions; and
transforming the returns data by at least one of grouping, ordering, or cleaning,
the transforming of the returns data to facilitate downstream processing;
apply feature engineering and business logic to the transformed returns data;
determine root cause analysis based on the applied feature engineering and business logic;
apply a machine learning technique based on the root cause analysis,
where the machine learning technique performs predictive modeling or forecasting associated with future returns; and
provide, to a user, at least one recommendation based on the applied machine learning technique,
the at least one recommendation associated with at least one of: customer engagement, business model efficiency, pricing and promotional strategies, inventory management decisions, future returns predictions, or customer behavior trends.

9. The method of claim 8, where the data source comprises at least one of a website, a document, enterprise resource planning (ERP) system, a point of sale (POS) device, a database, a web feed, a sensor, a geolocation data source, a server, an analytics tool, a mobile device, or a reporting system.

10. The method of claim 8, where the machine learning technique comprises at least one of a tree-based model, a Bayesian network, a support vector, clustering, a kernel method, a spline, or a knowledge graph.

11. The method of claim 8, where the machine learning technique comprises a deep learning technique using at a neural network and training at least one deep learning model.

12. The method of claim 11, where the deep learning model comprises at least one of a convolutional neural network, a feedforward neural network, a radial basis function neural network, a self-organizing neural network, a recurrent neural network, a sparse neural networks, or a modular neural network.

13. The method of claim 8, where pre-processing of the data is performed in conjunction with a data warehouse server.

14. The method of claim 8, further comprising:
transmitting, by an output interface, the at least one recommendation to the user at a user device.

15. A non-transitory computer-readable storage medium having machine-executable instructions stored thereon, which when executed instructs a processor to perform the following:
receive data associated with a plurality of customers;
receive data associated with a plurality of transactions associated with the plurality of customers,
where the plurality of transactions are transactions comprising at least a purchase, return, an exchange, or refund of an item, and
where the data associated with the plurality of customers and the data associated with the plurality of transactions are each received from a data source;
perform pre-processing of the data associated with the plurality of customers and the data associated with the plurality of transactions, where the pre-processing comprises:
extracting relevant returns data from the data associated with the plurality of customers and the data associated with the plurality of transactions; and
transforming the returns data by at least one of grouping, ordering, or cleaning,
the transforming of the returns data to facilitate downstream processing;
apply feature engineering and business logic to the transformed returns data;
determine root cause analysis based on the applied feature engineering and business logic;
apply a machine learning technique based on the root cause analysis,
where the machine learning technique performs predictive modeling or forecasting associated with future returns; and
provide, to a user, at least one recommendation based on the applied machine learning technique,
the at least one recommendation associated with at least one of: customer engagement, business model efficiency, pricing and promotional strategies, inventory management decisions, future returns predictions, or customer behavior trends.

16. The non-transitory computer-readable storage medium of claim 15, where the data source comprises at least one of a website, a document, enterprise resource planning (ERP) system, a point of sale (POS) device, a database, a web feed, a sensor, a geolocation data source, a server, an analytics tool, a mobile device, or a reporting system.

17. The non-transitory computer-readable storage medium of claim 15, where the machine learning technique comprises at least one of a tree-based model, a Bayesian network, a support vector, clustering, a kernel method, a spline, or a knowledge graph.

18. The non-transitory computer-readable storage medium of claim 15, where the machine learning technique comprises a deep learning technique using at a neural network and training at least one deep learning model.

19. The non-transitory computer-readable storage medium of claim 18, where the deep learning model comprises at least one of a convolutional neural network, a feedforward neural network, a radial basis function neural network, a self-organizing neural network, a recurrent neural network, a sparse neural networks, or a modular neural network.

20. The non-transitory computer-readable storage medium of claim 15, where pre-processing of the data is performed in conjunction with a data warehouse server.
